(19) United States
(12) Patent Application Publication
(10) Pub. No.: US 2008/0305741 A1
(43) Pub. Date: Dec. 11, 2008

(54) METHOD FOR AUTOMATICALLY PAIRING BETWEEN MOBILE DEVICE HAVING A HINGE PORTION AND A COUPLEABLE HARDWARE ACCESSORY

(75) Inventors: Peter FORNELL, Lake Oswego, OR (US); Amit Haller, Belmont, CA (US); Shai Farkash, Hod Hasharon (IL)

Correspondence Address: MERCHANT & GOULD PC, P.O. BOX 2903, MINNEAPOLIS, MN, 55402-0903, US

(73) Assignee: IXI Mobile (R&D) Ltd., Ra'anana (IL)

(21) Appl. No.: 12/028,961

(22) Filed: Feb. 11, 2008

(30) Foreign Application Priority Data
Feb. 11, 2007 (IL) 181263

(51) Int. Cl. H04B 7/00

(52) U.S. Cl. 455/41.2

(57) ABSTRACT

A system securely forming a short distance wireless network has a first device for generating a first signal including an identification symbol; and a second device for receiving the first signal over a wired data connection or proximity based wireless connection between the first and the second devices. The second device generates a second signal responsive to the second device generating a first signal including the identification symbol and receiving a second signal including a pairing message.

### FIELD OF THE INVENTION

The present invention relates to the field of electronic mobile devices. More particularly, the invention relates to a method for automatically pairing a mobile device and a hardware accessory which is coupleable to the mobile device.

### BACKGROUND OF THE INVENTION

Many electronic mobile devices, such as cellular telephones and the Ogo™ of IXI Mobile, USA have gained widespread appeal. The latter provides instant messaging, email, SMS, and voice receiving and transmitting services, as well as Web browsing capabilities. Due to their versatility and capabilities, these mobile devices are of great benefit to consumers.

A casing of many mobile devices is configured to be hingedly openable and closable. This casing is generally the outer face of the mobile device display, and the ability of the casing to be pivotable when opened or closed affords the mobile device increased compactness. It would be desirable, and this is the intent of the present invention, to utilize the volume of a fixed hinge portion for the insertion therein of a detachable hardware accessory and to thereby increase the versatility of the mobile device.

Such a detachable hardware accessory is disclosed, for example, in U.S. patent application having Attorney's docket No. 1005-43-01 USP, filed on Jan. 4, 2007. However in many implementations, such an accessory, when detached, remains in short-range wireless data communication (such as Bluetooth, WiFi or other similar wireless technology) with the mobile device in order to perform its functionality. This feature requires an a-priori pairing process, during which a device searches for other devices within the wireless proximity and establishes a unique relationship, using a process of unique identifications and end-user confirmations.

However, pairing (i.e., two devices establishing a unique relationship in a short distance wireless network) requires user intervention in order to create a secure relationship that the user is aware of and agrees to. This process can be cumbersome and intimidating to many users. In order to pair two devices in a short distance wireless network, the user has to find and select which devices to initiate pairing with, as well as to obtain, in case one of the devices has a predefined or fixed PIN code, and enter the PIN code accordingly. Also, a user sometimes does not know whether he entered an incorrect PIN code or if there is an error in a communication channel. He may waste time trying to obtain a connection rather than reentering a correct PIN. In addition, many devices and hardware accessories have limited user interfaces, such as a few keys and an LED, requiring users to read manuals in detail and press buttons in correct sequences and in a limited timeframe making the pairing process frustrating and sometimes impossible to complete. As many products and accessories have limited user interfaces and in an attempt to simplify the pairing process, many telecommunication equipment manufacturers have applied a fixed PIN code (e.g. 1234) to their product (e.g., 1234). This may compromise security, as the standard PIN numbers used by manufacturers are well known and published. Hence a different user can change an accessory to work with their short-distance wireless network instead.

All these entail a pairing process which is cumbersome, requires technical skills and may be time consuming

In the light of the above there is a need to provide a method that allows a user to efficiently and easily add a hardware accessory to a short distance wireless network thorough a proximity connection.

It is an object of the present invention to provide a method that allows a user to efficiently and easily add a hardware accessory to a short distance wireless network.

It is another object of the present invention to provide a method that allows a user to automatically add a hardware accessory to a short distance wireless network.

It is an additional object of the present invention to provide a method that minimizes the chance of a user to improperly enter a PIN code to the hardware accessory or to the mobile device.

It is an additional objective of the present invention to provide a method that allows a user to permanently pair a hardware accessory to a short distance wireless network

It is still an object of the present to provide a method that is highly secure.

Other objects and advantages of the invention will become apparent as the description proceeds.

### SUMMARY OF THE INVENTION

The present invention is directed to a system securely forming a short distance wireless network, that comprises a first device for generating a first signal including an identification symbol; and a second device for receiving the first signal over a wired data connection or proximity based wireless connection between the first and the second devices and for generating a second signal responsive to the second device generating a first signal including the identification symbol and receiving a second signal including a pairing message.

The wireless network may be compatible with BlueTooth or WiFi communication protocol. The pairing message may include a confirmation message. Data may be exchanged over the wired data connection using a unique communication protocol.

The present invention is also directed to a method for adding a first device to a short distance wireless network having a second device according to which an identification symbol is provided to the first device over a wired data connection between the devices. A signal containing the identification symbol is generated to the second device from the first device over the wired data connection. A pairing message is provided to the second device over the wired data connection and a wired communication channel is formed between the first device and the second device responsive to the identification symbol and the pairing message. The pairing message is generated automatically, in response to establishing the wired data connection.

### BRIEF DESCRIPTION OF THE DRAWINGS

In the drawings:

FIG. 1 is a perspective view of a hinge portion of a mobile device with which a hardware accessory is coupleable, according to one embodiment of the invention; and

FIG. 2 is a perspective view of a hinge portion of a mobile device, according to another embodiment of the invention.

### DETAILED DESCRIPTION OF PREFERRED EMBODIMENTS

The mobile device of the present invention utilizes the normally unused volume of the hinge portion for coupling thereto a hardware accessory that increases the performance of the mobile device, which is automatically recognizable and therefore may be coupled to the hinge portion without need for a user to manually reconfigure the settings of the mobile device.

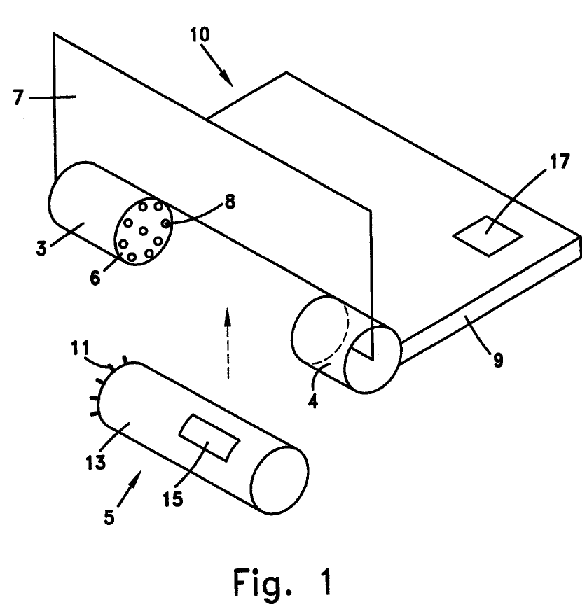

FIG. 1 illustrates one embodiment of fixed hinge portion 5 of a mobile device 10, with which an automatically recognizable hardware accessory 13 is coupleable. As shown, fixed hinge portion 5 of the mobile device is a cavity. Cavity 5 is interposed between two rotatable hinge portions 3 and 4 which allow a first casing portion 7 to be hingedly openable and closable with respect to a second casing portion 9, for increased compactness. A socket is formed on one longitudinal end 6 of the recessed hinge portion 5, and is provided with a plurality of recessed portions 8, for providing the necessary electrical and data connections to hardware accessory 15. Hardware accessory 13, which may be tubular, has a plurality of male contacts 11 projecting from one longitudinal end thereof to facilitate engagement with each corresponding recessed portions 8. It will be appreciated that longitudinal end 6 may be formed with male projections and the corresponding longitudinal end of hardware accessory 13 may be formed with female recessed portions.

Hardware accessory 13 has a processor 15 which enables the transmission of data to the main processor 17 of mobile device 10. When hardware accessory 13 is coupled to fixed hinge portion 5, main processor 17 automatically recognizes hardware accessory 13 and the operating system is automatically reconfigured so that data transmission can proceed between accessory processor 15 and main processor 17.

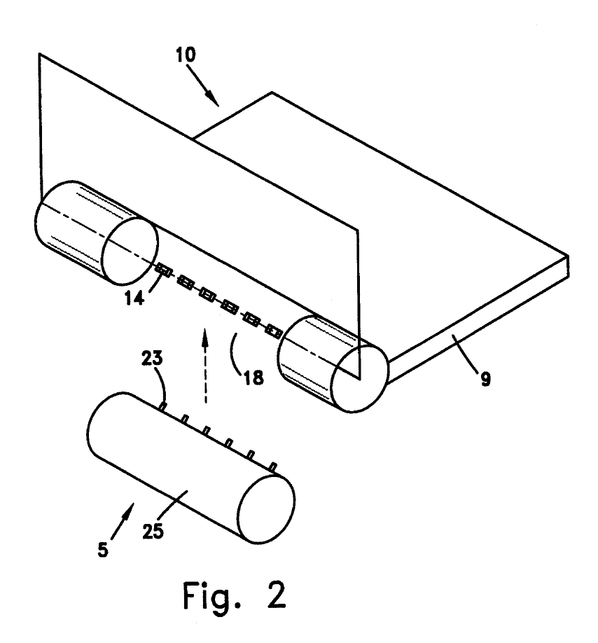

In another embodiment of the invention illustrated in FIG. 2, cavity 5 of the fixed hinge portion has a plurality of recessed portions 14 formed on circumferential wall 18 of the cavity which is contiguous with casing 9 of mobile device 10. Hardware accessory 25 has a plurality of protruding contacts 23 which radially protrude from the periphery thereof, to mate with corresponding recessed portions 14.

The hardware accessory that can be coupled with the mobile device can be a Detachable Short-Range Transceiver, a Portable Memory, or an interface to wireless earphones for playing content transmitted from the mobile device.

When the hardware accessory 13 is attached to the mobile device 10, several contacts 11 are used to charge the internal battery of the hardware accessory 13 from a power supply in the mobile device 10. At the same time, according to the present invention, the remaining contacts 11 are used as a data exchange channel, through which an automatic pairing process is initiated in parallel to battery charging. This way, by using the physical data contact, both devices can exchange pairing codes conveniently and securely. Moreover, using this paring process, the user only has to insert the accessory the first time, which the user has to do anyway in order to enjoy the functionality of the accessory 13 or to charge it, and the pairing process can take place automatically and without the users intervention.

According to an embodiment of the present invention, after the hardware accessory 13 is attached to the mobile device 10, a paring message is provided to the mobile device 10. An identification symbol is provided to the hardware accessory 13 and a signal containing the identification symbol to the second device is generated from the mobile device 10. A communication channel between the hardware accessory 13 is attached to the mobile device 10 is formed, in response to the paring message and the identification symbol.

This advantage is also implemented when from some reason the user changes the hardware accessory 13 and/or the mobile device 10 (e.g., when one of them is lost, stolen or stops functioning properly). Also, the fact that the pairing procedure is made though a wired connection or short proximity wireless connection allows to exchange pairing codes in a secure manner

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A system securely forming a short distance wireless network, comprising:
a) a first device for generating a first signal including an identification symbol; and
b) a second device for receiving said first signal over a wired data connection or proximity based wireless connection between said first and said second devices and for generating a second signal responsive to said second device generating a first signal including the identification symbol and receiving a second signal including a pairing message.

2. The system of claim 1, wherein the wireless network is compatible with BlueTooth communication protocol.

3. The system of claim 1, wherein the wireless network is compatible with WiFi communication protocol.

4. A system according to claim 1, wherein the pairing message includes a confirmation message.

5. A system according to claim 1, wherein data is exchanged over the wired data connection using a unique communication protocol.

6. A method for adding a first device to a short distance wireless network having a second device, comprising:
a) providing an identification symbol to said first device over a wired data connection between said devices;
b) generating a signal containing the identification symbol to said second device from said first device over said wired data connection;
c) providing a pairing message to said second device over said wired data connection; and
d) forming a wired communication channel between the first device and the second device responsive to the identification symbol and the pairing message.
wherein the pairing message is generated automatically, in response to establishing said wired data connection.
